(19) United States
(12) Patent Application Publication
(10) Pub. No.: US 2009/0247397 A1
(43) Pub. Date: Oct. 1, 2009

(54) MANUFACTURE METHOD FOR SUPPORTED METAL CATALYST

(76) Inventors: Kazushi Mashima, Osaka-fu (JP); Masato Ohashi, Osaka-fu (JP); Akihiro Yagyu, Hyougo-ken (JP); Hirohito Hirata, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/281,215

(22) PCT Filed: Feb. 28, 2007
(86) PCT No.: PCT/IB2007/000530

§ 371 Date: Nov. 12, 2008

(30) Foreign Application Priority Data
Mar. 1, 2006 (JP) 2006-055602

(51) Int. Cl. B01J 31/12

(52) U.S. Cl. 502/171

(57) ABSTRACT

A manufacture method for a metal-supported catalyst in accordance with an embodiment of the invention includes: binding a compound having a coordinatable functional group onto a catalyst support; impregnating the catalyst support to which the compound having the coordinatable functional group is bound, with a solution that contains a metal complex in which a ligand is coordinated to one catalyst metal atom or a plurality of catalyst metal atoms of the same kind, and substituting at least partially the ligand coordinated in the metal complex with the coordinatable functional group of the compound bound to the metal oxide support; and drying and firing the catalyst support impregnated with the solution.

### BACKGROUND OF THE INVENTION

1. Field of the Invention

The invention relates to a manufacture method for a metal-supported catalyst in which a catalyst metal is supported on a catalyst support.

2. Description of the Related Art

A size-controlled metal cluster is different from a bulk metal in chemical characteristics, such as catalytic activity and the like, and physical characteristics, such as magnetism and the like.

In order to efficiently utilize the peculiar characteristics of the metal cluster, a method for easily synthesizing a size-controlled cluster in large amount is needed. A known method for obtaining such a cluster is a method in which (i) clusters of various sizes are produced by causing a metal target to evaporate in vacuum, and (ii) the thus-obtained clusters are separated according to cluster sizes through the use of the principle of the mass spectrum. However, this method is not able to easily synthesize a cluster in large amount.

The peculiar characteristics of the cluster is disclosed in, for example, “Adsorption and Reaction of Methanol Molecule on Nickel Cluster Ions, Niₙ⁺ (n=3-11)”, M. Ichihashi, T. Hanmura, R. T. Yadav and T. Kondow, J. Phys. Chem. A, 104, 11885 (2000) (Related Art 1). This document discloses that the reactivity between methane molecules and platinum catalyst in the gas phase is greatly affected by the platinum cluster size, and that there exists a particular platinum cluster size that is optimal for the reaction, for example, as shown in FIG. 1.

Examples of utilization of the catalytic performance of a noble metal include purification of exhaust gas discharged from an internal combustion engine, such as an automotive engine or the like. At the time of the purification of exhaust gas, exhaust gas components, such as carbon monoxide (CO), hydrocarbon (HC), nitrogen oxide (NO_{X}), etc., are converted into carbon dioxide, nitrogen and oxygen by catalyst components whose main component is a noble metal such as platinum (Pt), rhodium ah), palladium (Pd), iridium (Ir), etc. Generally, the catalyst component that is a noble metal is supported on a support made of an oxide, such as alumina or the like, in order to enlarge the contact area for exhaust gas and the catalyst component.

In order to support a noble metal on an oxide support, the oxide support is impregnated with a solution of a nitric acid salt of a noble metal or a noble metal complex having one noble metal atom so that the noble metal compound is dispersed on surfaces of the oxide support, and then the support impregnated with the solution is dried and fired. In this method, however, it is not easy to control the size and the number of atoms of the noble metal cluster.

With regard to such catalysts for exhaust gas purification, too, the supporting of a noble metal in the form of clusters has been proposed in order to further improve the exhaust gas purification capability. For example, Japanese Patent Application Publication No. JP-A-11-285644 (Related Ail 2) discloses a technology in which a catalyst metal is supported in the form of ultrafine particle directly on a support through the use of a metal cluster complex that has a carbonyl group as a ligand.

Furthermore, Japanese Patent Application Publication No. JP-A-2003-181288 (Related Art 3) discloses a technology in which a noble metal catalyst having a controlled cluster size is manufactured by introducing a noble metal into pores of a hollow carbon material, such as carbon nanotube or the like, and fixing the carbon material with the noble metal introduced therein to an oxide support, and then firing it.

Still further, Japanese Patent Application Publication No. JP-A-9-253490 (Related Art 4) discloses a technology in which a metal cluster made up of an alloy of rhodium and platinum dissolved in the solid state is obtained by adding a reductant to a solution containing rhodium ions and platinum ions.

### SUMMARY OF THE INVENTION

The invention provides a manufacture method for a metal-supported catalyst in which a size-controlled cluster catalyst is supported with a high degree of dispersion.

A manufacture method for a metal-supported catalyst in accordance with an aspect of the invention includes: binding a compound having a coordinatable functional group onto a catalyst support; impregnating the catalyst support to which the compound having the coordinatable functional group is bound, with a solution that contains a metal complex in which a ligand is coordinated to one catalyst metal atom or a plurality of catalyst metal atoms of the same kind, and substituting at least partially the ligand coordinated in the metal complex with the coordinatable functional group of the compound; and drying and firing the catalyst support impregnated with the solution.

It is to be noted herein that in the invention, the “binding” between a catalyst support and a compound having a coordinatable functional group includes not only a definite chemical bond, but also so-called adsorption due to the affinity between a catalyst support and a compound having a coordinatable functional group.

According to the foregoing aspect, since the ligand coordinated in the metal complex is at least partially substituted with the ligand of the compound bound to the catalyst support, the metal complex is fixed onto the catalyst support, so that movement of the metal complex on the catalyst surfaces is restrained. Thus, it is possible to obtain a supported-type catalyst in which a catalyst metal, particularly a catalyst metal in the form of clusters, is supported with high degree of dispersion.

In the foregoing aspect, the metal complex may be a polynuclear complex.

According to this aspect, a cluster having the same number of metal atoms as contained in the metal complex can be obtained.

In the foregoing aspect, the compound bound to the catalyst support may have a plurality of coordinatable functional groups.

According to this aspect, since the compound on the support surfaces has a plurality of metal complexes, a cluster having a number of metal atoms that is equal to the total number of metal atoms contained in these metal complexes can be obtained.

In the foregoing aspect, the coordinatable functional group of the compound and a functional group of the ligand which is coordinated to the catalyst metal may be each independently selected from the group consisting of:

—COO⁻, —CR¹R²—O⁻, —NR¹⁻, —NR¹R², —CR¹═N—R², —CO—R¹, —PR¹R², —P(═O)R¹R², —P(OR¹)(OR²), —S(═O)₂R¹, —S⁺(—O⁻)R¹, —SR¹, and —CR¹R²—S⁻ (R¹ and R² each independently are hydrogen or a monovalent organic group).

In the foregoing aspect, the functional group of the compound and the functional group of the ligand which is coordinated to the catalyst metal may be the same.

According to this aspect, the ligand coordinated in the metal complex can be at least partially substituted with the coordinatable functional group of the compound bound to the catalyst support, in a state where the metal complex is relatively stable.

In the foregoing aspect, the catalyst support may be a metal oxide catalyst support.

According to this aspect, the compound having a coordinatable functional group can be bound to the metal oxide catalyst support by reacting the compound with a hydroxyl group of the metal oxide catalyst support.

### BRIEF DESCRIPTION OF THE DRAWINGS

The foregoing and/or further objects, features and advantages of the invention will become more apparent from the following description of preferred embodiment with reference to the accompanying drawings, in which like numerals are used to represent like elements and wherein:

FIG. 1 is a graph showing a relationship between the cluster size of Pt and the reactivity extracted from Related Art 1;

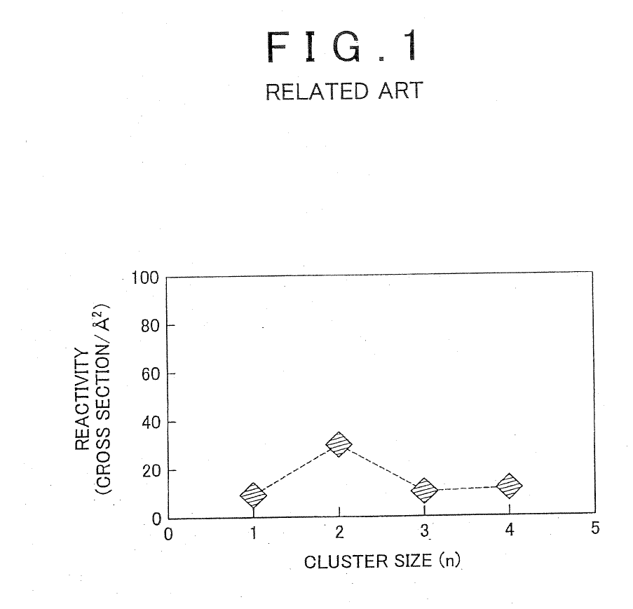

FIG. 2 is a schematic diagram of a scheme of Example 1;

FIG. 3 is a schematic diagram of a scheme of Example 2;

FIG. 4 is a schematic diagram of the scheme of Example 2;

FIG. 5 shows a TEM photograph in which the appearance of Pt on MgO prepared by a method of Example 2 was observed; and

FIG. 6 is a schematic diagram of a scheme of Example 4.

### DETAILED DESCRIPTION OF THE PREFERRED EMBODIMENTS

In the following description, the present invention will be described in more detail in terms of exemplary embodiments.

A metal-supported catalyst in accordance with an embodiment is manufactured by the following procedure: (a) binding a compound having a coordinatable functional group onto a catalyst support; (b) impregnating the catalyst support to which the compound having the coordinatable functional group is bound, with a solution that contains a metal complex in which a ligand is coordinated to one catalyst metal atom or a plurality of catalyst metal atoms of the same kind, and substituting at least partially the ligand coordinated in the metal complex with the coordinatable functional group of the compound; and (c) drying and firing the catalyst support impregnated with the solution.

(Metal that Becomes a Nucleus of a Metal Complex)

The catalyst metal that becomes a nucleus of a metal complex used in this embodiment may be an arbitrary metal that can be used as a catalyst. Therefore, this catalyst metal may be either a main group metal or a transition metal. This catalyst metal may be particularly a transition metal, and more particularly fourth to eleventh group transition metals, for example, a metal selected from the group consisting of titanium, vanadium, chrome, manganese, iron, cobalt, nickel, zirconium, niobium, molybdenum, technetium, ruthenium, rhodium, palladium, silver, hafnium, tantalum, tungsten, rhenium, osmium, iridium, platinum, and gold. Examples of commonly used catalyst metals include iron group elements (iron, cobalt, nickel), copper, platinum group elements (ruthenium, rhodium, palladium, osmium, iridium and platinum), gold, and silver.

(Metal Complex)

The metal complex used in the manufacture method for a metal-supported catalyst in accordance with the embodiment may be an arbitrary metal complex in which a ligand is coordinated to one catalyst metal atom or a plurality of catalyst metal atoms of the same kind. That is, the metal complex may be a polynuclear complex, for example, a complex that has 2 to 10 metal atoms, particularly 2 to 5 metal atoms.

This metal complex may be an arbitrary metal complex. Concrete examples of the metal complex include [Pt₄(CH₃COO)₈], [Pt(acac)₂] (“acac” is an acetyl acetonato ligand), [Pt(CH₃CH₂NH₂)₄₁]Cl₂, [Rh₂(C₆H₅COO)₄], [Rh₂(CH₃COO)₄], [Rh₂(OOCC₆H₄COO)₂], [Pd(acac)₂], [Ni(acac)₂], [Cu(C₁₁H₂₃COO)₂]₂, [Cu₂(OOCC₆H₄COO)₂], [Cu₂(OOCC₆H₄CH₃)₄], [Mo₂(OOCC₆H₄COO)₂], [Mo₂(CH₃COO)₄], and [N(n-C₄H₉)₄][Fe^{II}Fe^{III}(ox)₃] (“ox” is al oxalic acid ligand).

(Ligand of Metal Complex)

The ligand of the metal complex may be arbitrarily selected, taking into consideration the stability of the metal complex, the ease of substitution of the ligand with the compound bound onto the catalyst support, etc. The ligand of the metal complex may be a unidentate ligand, or a polydentate ligand such as a chelate ligand.

This ligand of the metal complex may be a hydrogen group to which one functional group selected from the group consisting of functional groups mentioned below is bound, or an organic group to which one or more functional groups selected from the group consisting of functional groups mentioned below are bound, particularly an organic group to which one functional group or two or more same functional groups selected from the group consisting of: —COO⁻ (carboxy group), —CR¹R²—O⁻ (alkoxy group), —NR¹⁻ (amide group), —NR¹R² (amine group), —CR¹═N—R² (imine group), —CO—R¹ (carbonyl group), —PR¹R² (phosphine group), —P(═O)R¹R² (phosphine oxide group), —P(OR¹)(OR²) (phosphite group), —S(═O)₂R¹ (sulfone group), —S⁺(—O⁻)R¹ (sulfoxide group), —SR¹ (sulfide group), and —CR¹R²—S⁻ (thiolato group); and particularly —COO⁻ (carboxy group), —CR¹R²—O⁻ (alkoxy group), —NR¹⁻ (amide group), and —NR¹R² (amine group) (R¹ and R² each independently are hydrogen or a monovalent organic group).

The organic group to which a functional group is bound may be a substituted or non-substituted hydrocarbon group, particularly a substituted or non-substituted hydrocarbon group of C₁ to C₃₀ (i.e., whose carbon atom number is 1 to 30; this will be applied in the following description as well), that may have a heteroatom, an ether bond or an ester bond. In particular, this organic group may be an alkyl group, an alkenyl group, an alkynyl group, an aryl group, an aralkyl group or a monovalent alicyclic group of C₁ to C₃₀, particularly C₁ to C₁₀. More particularly, this organic group may be an alkyl group, an alkenyl group, an alkynyl group of C₁ to C₅, particularly C₁ to C₃.

R¹ and R² may each independently be hydrogen, or a substituted or non-substituted hydrocarbon group, particularly a substituted or non-substituted hydrocarbon group of C₁ to C₃₀, that may have a heteroatom, an ether bond or an ester bond. Particularly, R¹ and R² may be hydrogen, or an alkyl group, an alkenyl group, an alkynyl group, an aryl group, an aralkyl group or a monovalent alicyclic group of C₁ to C₃₀, particularly C₁ to C₁₀. More particularly, R¹ and R² may be hydrogen, or an alkyl group, an alkenyl group or an alkynyl group of C₁ to C₅, particularly C₁ to C₃.

Examples of the ligand of the metal complex include a carboxylic acid ligand (R—COO⁻), an alkoxy ligand (R—CR¹R²—O⁻), an amide ligand (R—NR¹⁻), an amine ligand (R—NR¹R²), an imine ligand (R—CR¹═N—R²), a carbonyl ligand (R—CO—R¹), a phosphine ligand (R—PR¹R²), a phosphine oxide ligand (R—P(═O)R¹R²), a phosphite ligand (R—P(OR¹)(OR²)), a sulfone ligand (R—S(—O)₂R¹), a sulfoxide ligand (R—S⁺(—O⁻)R¹), a sulfide ligand (R—SR¹), and a thiolato ligand (R—CR¹R²—S⁻) (R is hydrogen or an organic group, and R¹ and R² are as mentioned above).

Concrete examples of the carboxylic acid ligand include a formic acid (formato) ligand, an acetic acid (acetato) ligand, a propionic acid (propionato) ligand, and an ethylenediaminetetraacetic acid ligand.

Concrete examples of the alkoxy ligand include a methanol (methoxy) ligand, an ethanol (ethoxy) ligand, a propanol (propoxy) ligand, a butanol (butoxy) ligand, a pentanol (pentoxy) ligand, a dodecanol (dodecyloxy) ligand, and a phenol (phenoxy) ligand.

Concrete examples of the amide ligand include a dimethyl amide ligand, a diethyl amide ligand, a di-n-propyl amide ligand, a diisopropyl amide ligand, a di-n-butyl amide ligand, a di-t-butyl amide ligand, and a nicotinamide.

Concrete examples of the amine ligand include methyl amine, ethyl amine, methyl ethyl amine, trimethyl amine, triethyl amine, ethylene diamine, tributyl amine, hexamethylene diamine, aniline, propylene diamine, trimethylene diamine, diethylene triamine, triethylene tetramine, tris(2-aminoethyl)amine, ethanol amine, triethanol amine, diethanol amine, piperidine, triethylene tetramine, and triethylene diamine.

Concrete examples of the imine ligand include diimine, ethyleneimine, ethyleneimine, propyleneimine, hexamethyleneimine, benzophenoneimine, methyl ethyl ketone imine, pyridine, pyrazole, imidazole, and benzoimidazole.

Concrete examples of the carbonyl ligand include carbon monoxide, acetone, benzophenone, acetyl acetone, acenaphthoquinone, hexafluoroacetyl acetone, benzoyl acetone, trifluoroacetyl acetone, and dibenzoyl methane.

Concrete examples of the phosphine ligand include phosphorus hydride, methyl phosphine, dimethyl phosphine, trimethyl phosphine, and diphosphine.

Concrete examples of the phosphine oxide ligand include tributyl phosphine oxide, triphenyl phosphine oxide, and tri-n-octyl phosphine oxide.

Concrete examples of the phosphite ligand include triphenyl phosphite, tritolyl phosphite, tributyl phosphite, and triethyl phosphite.

Concrete examples of the sulfone ligand include hydrogen sulfide, dimethyl sulfone, and dibutyl sulfone.

Concrete examples of the sulfoxide ligand include a dimethyl sulfoxide ligand, and a dibutyl sulfoxide ligand.

Concrete examples of the sulfide ligand include ethyl sulfide, butyl sulfide, etc.

Concrete examples of the thiolato ligand include a methanethiolate ligand, and a benzenethiolato ligand.

(Compound Bound onto Catalyst Support)

The compound bound onto the catalyst support may be an arbitrary compound that has a functional group capable of substituting a ligand of the metal complex.

This compound may have a functional group for binding the compound to the catalyst support. Examples of the functional group of this compound include functional groups mentioned above in conjunction with the ligand of the metal complex. Particularly, in the case where the catalyst support is a metal oxide support, the functional group capable of binding may particularly be a hydroxyl group and a carboxy group. The hydroxyl group and the carboxy group are capable of reacting with a hydroxyl group on a surface of the metal oxide support, particularly undergoing dehydration condensation therewith, so as to bind the compound having a coordinatable functional group to the metal oxide support. The functional group for binding the compound to the catalyst support may be the same functional group as the coordinatable functional group of the compound. In that case, the compound has a plurality of same functional groups, and one or more of these same functional groups function as functional groups for binding the compound to the catalyst support, and the other functional group or groups function as coordinatable functional groups for substituting the ligand of the metal complex.

Examples of the coordinatable functional group of the compound include functional groups mentioned above in conjunction with the ligand of the metal complex. The coordinatable functional group is selected so as to be able to substitute the ligand coordinated in the metal complex to be used a raw material. Therefore, generally, the functional group capable of substituting the ligand of the metal complex is a functional group that has stronger coordinating power than the ligand coordinated in the metal complex to be used as a raw material, particularly a functional group that has stronger coordinating power than the ligand coordinated in the metal complex to be used as a raw material and that has the same functional group as the ligand does. In order to accelerate the substitution of the ligand of the metal complex with the coordinatable functional group of the compound, the compound may be used in relatively large amount.

In the case where the compound bound onto the catalyst support has a plurality of coordinatable functional groups, the ligands may be disposed with a certain space left therebetween in order to avoid the steric hindrance between the metal complexes. However, if the space is excessively large, there arises a possibility of making it difficult to obtain a single cluster from the plurality of complexes coordinated to the plurality of functional groups.

The compound bound onto the catalyst support may be a compound that has two or more of any one species of the functional groups mentioned above in conjunction with the ligand of the metal complex, for example, a plurality of carboxy groups. In this case, one or more of these functional groups may be used for the binding with the catalyst support, and the other functional group or groups may be used as coordinatable functional groups, as stated above. Therefore, for ex ample, the compound bound onto the catalyst support may be a dicarboxylic acid, a tricarboxylic acid or a tetracarboxylic acid of C₂ to C₃₀, particularly C₂ to C₁₀, or a benzenedicarboxylic acid, a benzenetricarboxylic acid, or a benzenetetracarboxylic acid.

More concrete examples of the dicarboxylic acid include oxalic acid, malonic acid, succinic acid, glutaric acid, adipic acid, pimelic acid, suberic acid, azelaic acid, sebacic acid, phthalic acid, isophthalic acid, and terephthalic acid. More concrete examples of the tricarboxylic acid include trimesic acid (1,3,5-benzenetricarboxylic acid). More concrete examples of the tetracarboxylic acid include 1,2,3,5-benzernetetracarboxylic acid.

In the case where a compound that has a plurality of coordinatable functional groups when bound to the catalyst support is used, a number of metal complexes that is greater than the number of the functional groups are needed in order to coordinate the metal complexes to all the functional groups. Therefore, for example, in the case where trimesic acid (1,3,5-benzenetricarboxylic acid) is used as this compound, 2 mol of the metal complex is needed with respect to 1 mol of trimesic acid in order to coordinate two metal complexes to each molecule of trimesic acid on the assumption that one of the carboxy groups of trimesic acid is bound to the catalyst support.

(Drying and Firing Condition)

The drying and firing of the catalyst support impregnated with a metal complex-containing solution may be performed in a condition of a temperature and a time that are sufficient to obtain a metal or metal oxide cluster. For example, the drying is performed at a temperature of 120 to 250° C. for 1 to 2 hours, and then the firing is performed at a temperature of 400 to 600° C. for 1 to 3 hours. The solvent of the solution to be used in this process may be an arbitrary solvent that is capable of stably maintaining a multiple-metal complex-containing compound, for example, an aqueous solvent, or an organic solvent such as dichloroethane or the like.

(Catalyst Support)

The catalyst support to be used in the manufacture method for a metal-supported catalyst in accordance with the embodiment may be a metal oxide support, for example, a metal oxide support selected from the group consisting of alumina, ceria, zirconia, silica, titania, and their combinations. The catalyst support may be a porous support.

The invention will be described hereinafter with reference to examples. The examples shown below are merely for illustration of the invention, and do not limit the invention in any manner.

### Example 1

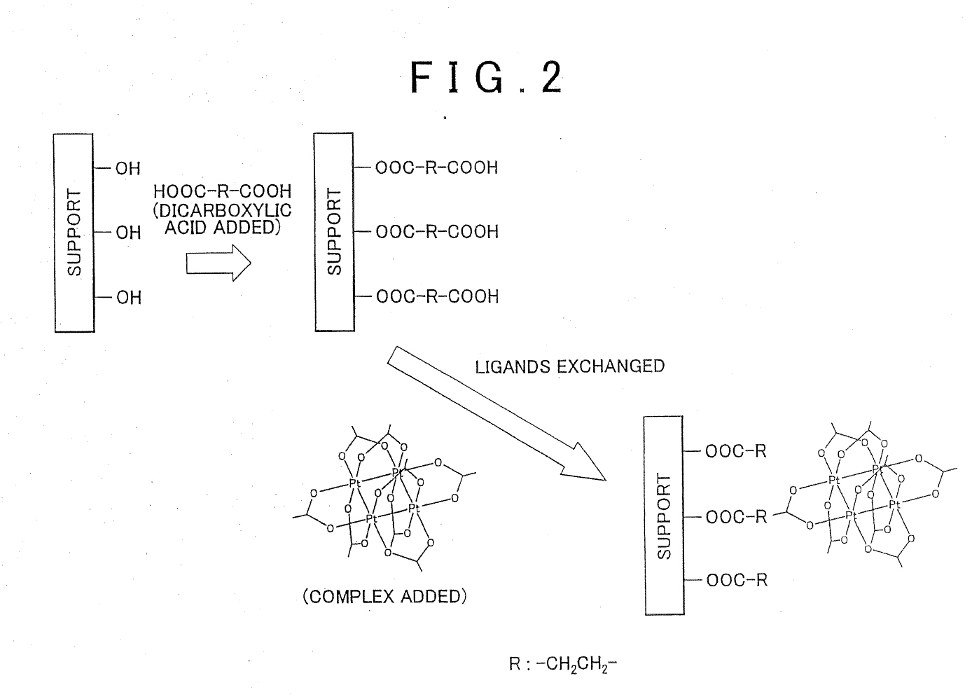

FIG. 2 shows a scheme of Example 1.

(Synthesis of [Pt₄(CH₃COO)₈])

The synthesis of the compound was performed using a procedure described in “Jikken Kagaku Kouza (Experimental Chemistry Course)”, 4th ed., Vol. 17, p. 452, Maruzen (1991). That is, the synthesis was performed as follows. 5 g of K₂PtCl₄ was dissolved in 20 ml of warm water, and 150 ml of glacial acetic acid was added to the solution. Then, 8 g of silver acetate was added regardless of the presence/absence of precipitation of K₂PtCl₄. This slurry-like material was refluxed for 3 to 4 hours while being stirred by a stirrer. After the material was let to cool, black precipitation was filtered out. Through the use of a rotary evaporator, acetic acid was removed by concentrating brown precipitation as much as possible. This concentrate was combined with 50 ml of acetonitrile, and the mixture was left standing. The produced precipitation was filtered out, and the filtrate was concentrated again. Substantially the same operation was performed on the concentrate three times. The final concentrate was combined with 20 ml of dichloromethane, and was subjected to adsorption on a silica gel column. The elution was performed with dichloromethane-acetonitrile (5:1), and a red extract was collected and concentrated to obtain a crystal.

(Pretreatment of a Support with Dicarboxylic Acid)

10 g of magnesium oxide (MgO) was dispersed in 100 g of ethanol. While this MgO dispersed solution was being stirred, a solution obtained by dissolving 100 mg of succinic acid (HOOC—CH₂CH₂—COOH), that is, a dicarboxylic acid, in 50 g of ethanol was added to the dispersed solution. The mixture was stirred for 30 min so as to allow succinic acid to adsorb to MgO. After that, MgO and the solution was separated by centrifugal separation. The thus-obtained MgO was washed and separated through the use of 100 g of ethanol three times to remove the succinic acid that did not react with MgO. The thus-obtained MgO was air-dried to obtain a succinic acid-treated MgO.

(Supporting of [Pt₄(CH₃COO)₈])

10 g of the succinic acid-treated MgO obtained as described above was dispersed in 200 g of acetone. While the MgO dispersed solution was being stirred, a solution obtained by dissolving 16.1 mg of [Pt₄(CH₃COO)₈] in 100 g of acetone was added. Then, the mixture was stirred for 30 min. When the stirring was stopped, reddish MgO precipitated, and the supernatant liquid became transparent (i.e., [Pt₄(CH₃COO)₈] adsorbed to the succinic acid-treated MgO).

### Comparative Example 1

[Pt₄(CH₃COO)₈] was supported on the MgO support in substantially the same manner as in Example 1, except that the pretreatment of the support with dicarboxylic acid was not performed. Specifically, 10 g of the MgO not subjected to the dicarboxylic acid pretreatment of the support was dispersed in 200 g of acetone. While the MgO dispersed solution was being stirred, a solution obtained by dissolving 16.1 mg of [Pt₄(CH₃COO)₈] in 100 g of acetone was added. Then, the mixture was stirred for 30 min. When the stirring was stopped, MgO precipitated, and the supernatant liquid became pale red (i.e., [Pt₄(CH₃COO)₈] did not adsorb to MgO).

### Example 2

### Synthesis of [Pt₄(CH₃COO)₇{O₂C(CH₂)₃CH—CH(CH₂)₃CO₂}(CH₃COO)₇Pt₄]

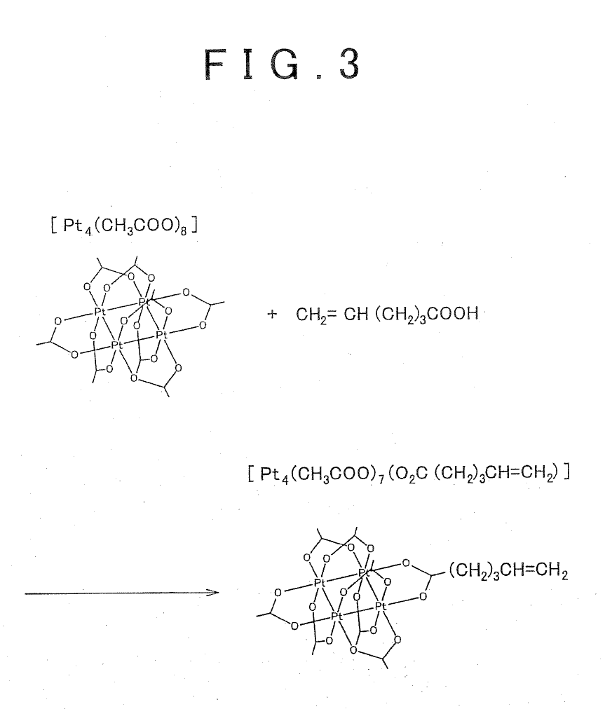

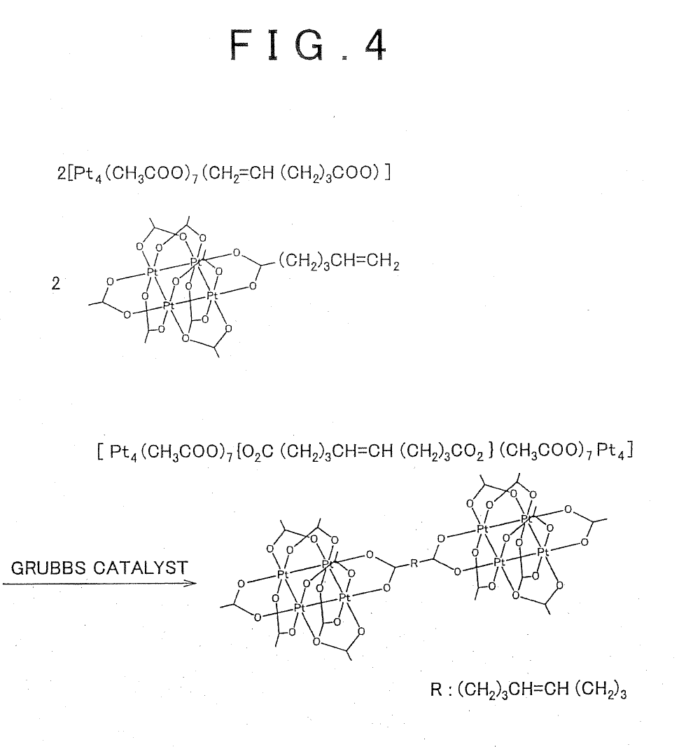

FIGS. 3 and 4 show a scheme of the synthesis of the compound.

Concretely, the compound was synthesized as follows. CH₂═CH(CH₂)₃CO₂H (19.4 μL, 18.6 mg) was added to a CH₂Cl₂ solution (10 mL) of [Pt₄(CH₃COO)₈] (0.204 g, 0.163 mmol) obtained as in Example 1. This changed the color of the solution from orange to red-orange. After the solution was stirred at room temperature for 2 hours, the solvent was removed by evaporation under reduced pressure, and the remaining substance was washed with diethyl ether (8 mL) twice. As a result, an orange solid of [Pt₄(CH₃COO)₇{O₂C(CH₂)₃CH═CH₂}] was obtained.

[Pt₄(CH₃COO)₇{O₂C(CH₂)₃CH═CH₂}] (362 mg, 0.277 mmol) synthesized as described above and a first-generation Grubbs catalyst (6.7 mg, 8.1 μmol, 2.9 mmol %) were placed in an argon-substituted Schlenk device, and were dissolved in CH₂Cl₂ (30 mL). A cooling pipe was attached to the Schlenk device, and a heated reflux was performed in an oil bath. After the solution was refluxed for 60 hours, the solvent was removed by evaporation under reduced pressure, and the remaining substance was dissolved in CH₂Cl₂. After that, filtration via a glass filter was performed. The filtrate was concentrated under reduced pressure to obtain a solid. The solid was washed with diethyl ether (10 mL) three times to obtain an orange solid of [Pt₄(CH₃COO)₇{O₂C(CH₂)₃CH═CH(CH₂)₃CO₂}(CH₃COO)₇Pt₄] as an E/Z type mixture.

Spectral data of [Pt₄(CH₃COO)₇{O₂C(CH₂)₃CH═CH₂}] is shown below.

¹H NMR (300 MHz, CDCl₃, 308K) δ: 1.89 (tt, ³J_{HH}=7.5, 7.5 Hz, 2H, O₂CCH₂CH₂—), 1.99 (s, 3H, ^{ax}O₂CCH₃), 2.00 (s, 3H, ^{ax}O₂CCH₃), 2.01 (s, 6H, ^{ax}O₂CCH₃), 2.10 (q like, 2H, —CH₂CH═CH₂), 2.44 (s, 6H, ^{eq}O₂CCH₃), 2.45 (s, 3H, ^{eq}O₂CCH₃), 2.70 (t, ³J_{HH}=7.5 Hz, 2H, O₂CCH₂CH₂—), 4.96 (ddt, ³J_{HH}=10.4 Hz, ²J_{HH}=1.8 Hz, ⁴J_{HH}=? Hz, 1H, —CH═C(H)^{cis}H), 5.01 (ddt, ³J_{HH}=17.3 Hz, ²J_{HH}=1.8 Hz, ⁴J_{HH}=? Hz, 1H, —CH═C(H)^{trans}H), 5.81 (ddt, ³J_{HH}=17.3, 10.4, 6.6 Hz, 1H, —CH═CH₂).

¹³C{¹H} NMR (75 MHz, CDCl₃, 308K) δ: 21.2, 21.2 (^{ax}O₂CCH₃), 22.0, 22.0 (^{eq}O₂CCH₃), 25.8 (O₂CCH₂CH₂—), 33.3 (—CH₂CH═CH₂), 35.5 (O₂CCH₂CH₂—), 115.0 (—CH═CH₂), 137.9 (—CH═CH₂), 187.5, 193.0, 193.1 (O₂CCH₃), 189-9 (O₂CCH₂CH₂—).

MS (ESI+, CH₃CN solution) m/z: 1347 ([M+sol.]⁺).

IR (KBr disk, ν/cm⁻¹): 2931, 2855 (ν_{C-H}), 1562, 1411 (ν_{COO-}), 1039, 917 (ν_{-C=C-}).

Spectral data of [Pt₄(CH₃COO)₇{O₂C(CH₂)₃CH═CH(CH₂)₃CO₂}(CH₃COO)₇Pt] is shown below.

Major (E Type):

¹H NMR (300 MHz, CDCl₃, 308K) δ: 1.83 (like, J=7.7 Hz, 4H, O₂CCH₂CH₂—), 2.00 (s, 6H, ^{ax}O₂CCH₃), 2.01 (s, 18H, ^{ax}O₂CCH₃), 2.02-2.10 (m, 4H, —C₂H═CH—), 2.44 (s, 18H, ^{eq}O₂CCH₃), 2.67 (t, ³J_{HH}=7.2 Hz, 4H, O₂CCH₂CH₂—), 5.37-5.45 (m, 2H, —CH═).

¹³C NMR (75 MHz, CDCl₃, 308K) δ: 21.17 (q, ¹J_{C-H}=130.9 Hz, ^{ax}O₂CCH₃), 21.22 (q, ¹J_{C-H}=131.1 Hz, ^{ax}O₂CCH₃), 21.9 (q, ¹H_{C-H}=129.4 Hz, ^{eq}O₂CCH₃), 22.0 (q, ¹J_{C-H}=129.4 Hz, ^{eq}O₂CCH₃), 26.4 (t, ¹J_{C-H}=127.3 Hz, O₂CCH₂CH₂—), 32.0 (t, ¹J_{C-H}=127.3 Hz, —CH₂CH═CH—), 35.5 (t, ¹J_{C-H}=130.2 Hz, O₂CCH₂CH₂—), 130.1 (d, ¹J_{C-H}=148.6 Hz, —CH═), 187.3, 187.4, 193.0 (O₂CCH₃), 189.9 (O₂CCH₂CH₂—).

Minor (Z Type):

¹H NMR (300 MHz, CDCl₃, 308K) δ: 1.83 (like, J=7.7 Hz, 4H, O₂CCH₂CH₂—), 2.00 (s, 6H, ^{ax}O₂CCH₃), 2.01 (s, 18H, ^{ax}O₂CCH₃), 2.02-2.10 (m, 4H, —CH₂CH═CH—), 2.44 (s, 18H, ^{eq}O₂CCH₃), 2.69 (t, ³J_{H-H}=7.2 Hz, 4H, O₂CCH₂CH₂—), 5.37-5.45 (m, 2H, —CH═).

¹³C NMR (75 MHz, CDCl₃, 308K) δ: 21.17 (q, ¹J_{C-H}=130.9 Hz, ^{ax}O₂CCH₃), 21.2₂ (q, ¹J_{C-H}=131.1 Hz, ^{ax}O₂CCH₃), 21.9 (q, ¹J_{C-H}=129.4 Hz, ^{eq}O₂CCH₃), 22.0 (q, ¹J_{C-H}=129.4 Hz, ^{eq}O₂CCH₃), 26.5 (t, ¹J_{C-H}=127.3 Hz, O₂CCH₂CH₂—), 26.7 (t, ¹J_{C-H}=127.3 Hz, —CH₂CH—CH—), 35.5 (t, ¹J_{C-H}=130.2 Hz, O₂CCH₂CH₂—), 129.5 (d, ¹J_{C-H}=154.3 Hz, —CH═), 187.3, 187.4, 193.0 (O₂CCH₃), 189.9 (O₂CCH₂CH₂—).

MS (ESI+, CH₃CN solution) m/z: 2584 ([M]⁺).

(Pretreatment of the Support with Dicarboxylic Acid)

A succinic acid-treated MgO was obtained in substantially the same manner as in Example 1.

(Supporting of [Pt₄(CH₃COD)₇{O₂C(CH₂)₃CH═CH(CH₂)₃CO₂}(CH₃COO)₇Pt₄])

10 g of the succinic acid-treated MgO obtained as described above was dispersed in 200 g of acetone. While this MgO dispersed solution was being stirred, a solution obtained by dissolving 16.6 mg of [Pt₄(CH₃COO)₇{O₂C(CH₂)₃CH═CH(CH₂)₃CO₂}(CH₃COO)₇Pt₄] in 100 g of acetone was added. Then, the mixture was stirred for 30 min. When the stirring was stopped, slightly orangish MgO precipitated, and the supernatant liquid became transparent (i.e., [Pt₄(CH₃COO)₇{O₂C(CH₂)₃CH═CH(CH₂)₃CO₂}(CH₃COO)₇Pt₄] adsorbed to the succinic acid-treated MgO).

### Comparative Example 2

[Pt₄(CH₃COO)₇{O₂C(CH₂)₃C═CH(CH₂)₃CO₂}(CH₃COO)₇Pt₄] was supported on the MgO support in substantially the same manner as in Example 2, except that the pretreatment of the support with dicarboxylic acid was not performed. Specifically, 10 g of the MgO not subjected to the dicarboxylic acid pretreatment of the support was dispersed in 200 g of acetone. While the MgO dispersed solution was being stirred, a solution obtained by dissolving 16.1 mg of [Pt₄(CH₃COO)₇{O₂C(CH₂)₃CH═CH(CH₂)₃CO₂}(CH₃COO)₇Pt₄] in 100 g of acetone was added. Then, the mixture was stirred for 30 min. When the stirring was stopped, MgO precipitated, and the supernatant liquid became pale red (i.e., [Pt₄(CH₃COO)₇{O₂C(CH₂)₃CH═CH(CH₂)₃CO₂}(CH₃COO)₇Pt₄] did not adsorb to MgO).

(TEM Observation of Clusters)

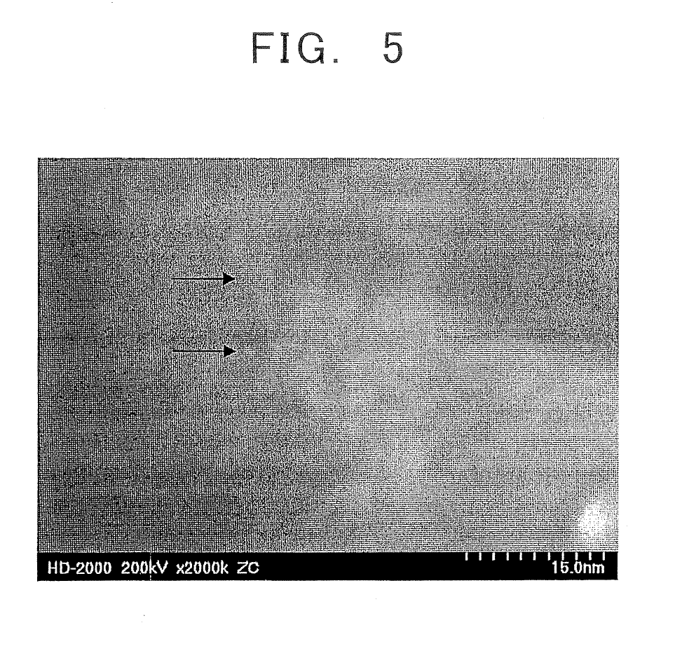

The appearance of the Pt on the MgO prepared by the foregoing method was observed by TEM. Using an HD-2000 type electron microscope of Hitachi, STEM images were observed at an acceleration voltage of 200 kV. An STEM image of Example 2 is shown in FIG. 5. In this image, Pt particles having a spot diameter of 0.9 nm estimated from the structure of 8-platinum atom clusters can be seen, demonstrating that, by the foregoing technique, 8-platinum atom clusters can be supported on an oxide support. That is, it has been demonstrated that the firing of a compound in which a plurality of metal complexes are bound via a ligand provides a cluster that has all the metal atoms contained in the compound.

### Example 3

### Synthesis of [Pt₄(CH₃COO)₈]

Using substantially the same procedure as in Example 1, [Pt₄(CH₃COO)₈] was obtained.

(Pretreatment of the Support with Dicarboxylic Acid)

3 g of γ-alumina (γ-Al₂O₃) was dispersed in 50 g of ethanol. While the γ-Al₂O₃ dispersed solution was being stirred, a solution obtained by dissolving 67 mg of adipic acid (HOOC—(CH₂)₄—COOH), that is, a dicarboxylic acid, in 50 g of ethanol was added. Then, the mixture was stirred for 30 min to allow adipic acid to adsorb to γ-Al₂O₃. After that, γ-Al₂O₃ and the solution was separated by centrifugal separation. The thus-obtained γ-Al₂O₃ was washed and separated with 50 g of ethanol three times to remove the adipic acid that did not react with γ-Al₂O₃. The thus-obtained γ-Al₂O₃ was air-dried to obtain an adipic acid-treated γ-Al₂O₃.

(Supporting of [Pt₄(CH₃COO)₈])

3 g of the adipic acid-treated γ-Al₂O₃ obtained as described above was dispersed in 50 g of acetone. While the γ-Al₂O₃ dispersed solution was being stirred, a solution obtained by dissolving 48.3 mg of [Pt₄(CH₃COO)₈] in 50 g of acetone was added. Then, the mixture was stirred for 30 min. When the stirring was stopped, slightly reddish γ-Al₂O₃ precipitated, and the supernatant liquid became transparent (i.e., [Pt₄(CH₃COO)₈] adsorbed to the adipic acid-treated γ-Al₂O₃).

### Comparative Example 3

[Pt₄(CH₃COO)₈] was supported on the γ-Al₂O₃ support in substantially the same manner as in Example 3, except that the pretreatment of the support with dicarboxylic acid was not performed. Specifically, 3 g of the γ-Al₂O₃ not subjected to the dicarboxylic acid pretreatment of the support was dispersed in 50 g of acetone. While the γ-Al₂O₃ dispersed solution was being stirred, a solution obtained by dissolving 48.3 mg of [Pt(CH₃COO)₈] in 50 g of acetone was added. Then, the mixture was stirred for 30 min. When the stirring was stopped, γ-Al₂O₃ precipitated, and the supernatant liquid became orange (i.e., [Pt₄(CH₃COO)₈] did not adsorb to γ-Al₂O₃).

### Example 4

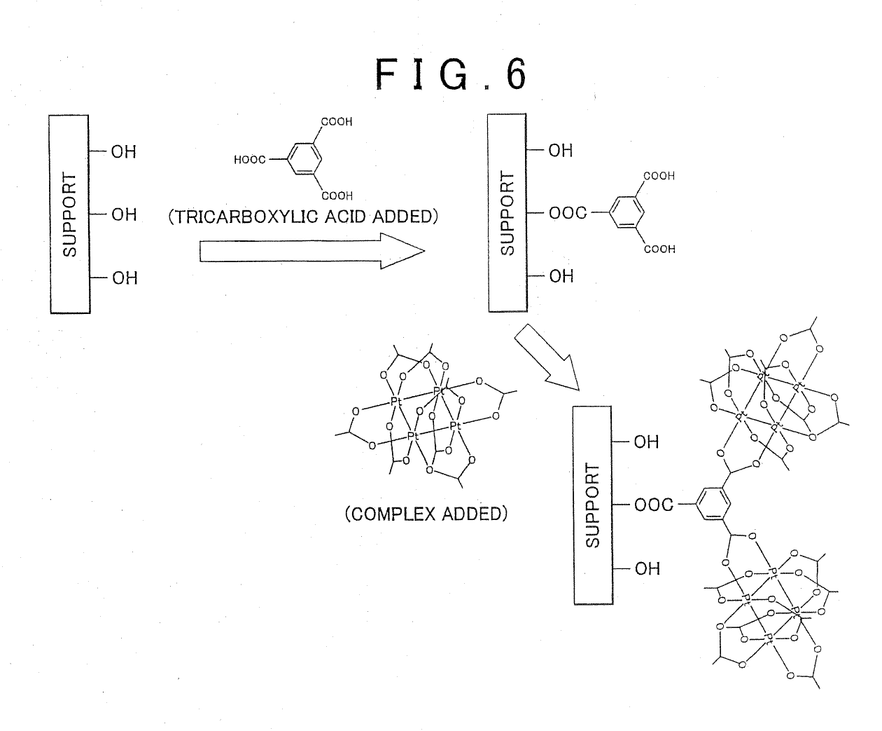

FIG. 6 shows a scheme of Example 4.

(Synthesis of [Pt₄(CH₃COO)₈])

Using substantially the same procedure as in Example 1, [Pt₄(CH₃COO)₈] was obtained.

(Pretreatment of the Support with Tricarboxylic Acid)

10 g of γ-alumina (γ-Al₂O₃) was dispersed in 100 g of ethanol. While the γ-Al₂O₃ dispersed solution was being stirred, a solution obtained by dissolving 6.7 mg (32 μmol) of trimesic acid (1,3,5-benzenetricarboxylic acid) in 50 g of ethanol was added. Then, the mixture was stirred for 30 min. After that, ethanol was removed from the solution by Using a rotary evaporator. The remaining substance was dried by using a vacuum dryer to obtain a trimesic acid-treated γ-Al₂O₃.

(Supporting of [Pt₄(C₃COO)₈])

3 g of the trimesic acid-treated γ-Al₂O₃ obtained as described above was dispersed in 100 g of acetone. While the γ-Al₂O₃ dispersed solution was being stirred, a solution obtained by dissolving 80.3 mg (64 μmol) of [Pt₄(CH₃COO)₈] in 100 g of acetone was added. Then, the mixture was stirred for 16 hours. When the stirring was stopped, pale orange γ-Al₂O₃ precipitated, and the supernatant liquid became transparent (i.e., [Pt₄(CH₃COO)₈] adsorbed to the trimesic acid-treated γ-Al₂O₃).

While the invention has been described with reference to exemplary embodiments thereof, it should be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

1. A manufacture method for a metal-supported catalyst, comprising:
binding a compound having a coordinatable functional group onto a catalyst support;
impregnating the catalyst support to which the compound is bound, with a solution that contains a metal complex in which a ligand is coordinated to one catalyst metal atom or a plurality of catalyst metal atoms of the same kind, and substituting at least partially the ligand coordinated in the metal complex with the coordinatable functional group of the compound; and
drying and firing the catalyst support impregnated with the solution.

2. The manufacture method for the metal-supported catalyst according to claim 1, wherein the metal complex is a polynuclear complex.

3. The manufacture method for the metal-supported catalyst according to claim 1, wherein the compound bound to the catalyst support has a plurality of coordinatable functional groups.

4. The manufacture method for the metal-supported catalyst according to claim 1, wherein the coordinatable functional group of the compound and a functional group of the ligand which is coordinated to the catalyst metal are each independently selected from the group consisting of:
—COO⁻, —CR¹R²—O⁻, —NR¹⁻, —NR¹R², —CR¹═N—R², —CO—R¹, —PR¹R², —P(═O)R¹, R², P(OR¹)(OR²), —S(═O)₂R¹, —S⁺(—O⁻)R¹, —SR¹, and —CR¹R²—S⁻ (R¹ and R² each independently are hydrogen or a monovalent organic group).

5. The manufacture method for the metal-supported catalyst according to claim 1, wherein the coordinatable functional group of the compound and a functional group of the ligand which is coordinated to the catalyst metal are the same.

6. The manufacture method for the metal-supported catalyst according to claim 1, wherein the catalyst support is a metal oxide catalyst support.
